(19) United States
(12) Patent Application Publication
(10) Pub. No.: US 2021/0382431 A1
(43) Pub. Date: Dec. 9, 2021

(54) LUBRICATION MECHANISM AND IMAGE FORMING DEVICE

(71) Applicant: Konica Minolta, Inc., Tokyo (JP)

(72) Inventor: Kuniaki KASHIWAKURA, Toyohashi-shi (JP)

(21) Appl. No.: 17/325,052

(22) Filed: May 19, 2021

(30) Foreign Application Priority Data
Jun. 8, 2020 (JP) 2020-099007

(51) Int. Cl. G03G 21/00; G06K 15/00; G06K 15/12

(52) U.S. Cl. CPC G03G 21/0094; G06K 15/1295; G06K 15/40

(57) ABSTRACT

A lubrication mechanism applies a lubricant to an image carrier of an image forming device. The lubrication mechanism includes a solidified lubricant rod, an application brush, a lubricant pressing part, and a controller. The application brush scrapes the lubricant from the lubricant rod and supplies the lubricant to the image carrier. The lubricant pressing part presses the lubricant rod against the application brush. The controller controls rotational drive of the application brush. The controller executes a detection mode of controlling a rotation speed of the application brush and detecting a value of a drive load of the application brush which corresponds to the rotation speed. The controller estimates a remaining amount of the lubricant rod based on the value of the drive load of the application brush and/or the rotation speed of the application brush at a time of detection.

### BACKGROUND

### 1. Technical Field

The present invention relates to an image forming device such as a copier, a printer, or a facsimile, which forms an image on a recording material in an electrophotographic method. More specifically, the present invention relates to an image forming device having a lubrication mechanism that applies a lubricant on a member to be cleaned, such as a photoreceptor.

### 2. Background Art

In recent years, electrophotographic image forming device is required to improve image quality, such as high resolution and photo reproducibility. Reducing particle size of a toner, which is a developer, is one of effective means for improving image quality. However, if a toner which has a small particle size and which is produced in a polymerization method or the like remains on an image carrier such as a photoreceptor after a transfer process, it firmly adheres to the image carrier. It is not sufficiently removed by a cleaning blade or the like. Therefore, one technique proposes to supply a substance that lowers a coefficient of friction of an image carrier onto the image carrier. For example, a lubricant made of zinc stearate or the like is applied onto an image carrier with a brush. Adhesion of a toner is reduced by applying the lubricant on the image carrier. The toner is sufficiently removed by a cleaning blade or the like.

An example of a conventional lubrication mechanism will be described.

The lubrication mechanism presses a lubricant rod, which is a solidified lubricant, against an application brush. The lubrication mechanism scrapes the lubricant from the lubricant rod by turning the application brush, and supplies it to a photoreceptor. In a case where the application brush is provided on the downstream side of the cleaning blade, an immobilization means (blade) that makes a film of the lubricant is provided downstream of the application brush.

The lubricant rod is held by attaching the rod to a holding sheet metal with double-sided tape. The lubricant rod takes a form of pushing the application brush from above and a form of pushing the application brush from below. In the form in which the lubricant rod pushes the application brush from above, weight of the lubricant rod may be applied to the application brush. In the form in which the lubricant rod pushes the application brush from below, a compression spring or a torsion coil spring may be provided between the holding sheet metal of the lubricant rod and a casing so that the lubricant rod pushes the application brush. Alternatively, swinging arms may be attached to both ends of the holding sheet metal. A tension spring is provided between the arms to pull the arms so that the lubricant rod pushes the application brush. In view of a degree of freedom of arrangement and a degree of freedom of pressure to be applied, a pressing means using force of a spring is generally used.

As the lubricant rod is consumed, the lubricant rod wears out so that the holding sheet metal approaches the application brush. Pressure of the pressing means gradually decreases. As the pressure decreases, an amount of the lubricant scraped by the application brush decreases. Therefore, a lubrication amount for the photoreceptor is reduced. Decrease in the lubrication amount brings various problems such as poor cleaning, poor transfer, and poor image due to increase in an amount of wear of the photoreceptor. As a countermeasure, as the lubricant rod is consumed, a rotation speed of the application brush is gradually increased to keep the lubrication amount.

However, when the lubricant rod is exhausted, the lubrication amount cannot be kept. A drum unit for lubrication or the lubricant rod is replaced.

A consumption speed of the lubricant rod, which is obtained by dividing a lubricant consumption by a photoreceptor mileage, is approximately constant. Therefore, a mileage of the photoreceptor is managed, and used as a guide for replacement. However, the consumption speed could vary depending on a user's usage environment, such as image pattern and usage environment. Therefore, sometimes a lubricant is used even after the lubricant is depleted.

To solve the above problems, some devices detect a remaining amount of a lubricant rod. A device that directly detects a position of a lubricant rod with a photo sensor or a displacement sensor, a current detection device combined with a resistor, and a device that detects continuity of contact points have been put into practical use or proposed (JP 2007-225847A, JP 2011-107592A, JP 2013-195899A).

However, conventional detection of a remaining amount of a lubricant rod requires a dedicated detection means or detection circuit. It brings problems of increase in cost and installation space.

### SUMMARY OF INVENTION

The present invention has been made in view of the above problems in the prior art. An object of the present invention is to estimate a remaining amount of a lubricant rod while preventing increase in the number of hardware elements.

To achieve the abovementioned object, according to an aspect of the present invention, a lubrication mechanism that applies a lubricant to an image carrier of an image forming device includes:

a lubricant rod that is solidified;

an application brush that scrapes the lubricant from the lubricant rod and supplies the lubricant to the image carrier;

a lubricant pressing part that presses the lubricant rod against the application brush; and

a controller that controls rotational drive of the application brush,

wherein

the controller executes a detection mode of controlling a rotation speed of the application brush and detecting a value of a drive load of the application brush which corresponds to the rotation speed, and

the controller estimates a remaining amount of the lubricant rod based on the value of the drive load of the application brush and/or the rotation speed of the application brush at a time of detection.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 shows a photosensitive drum and a lubrication mechanism of an image forming device.

FIG. 2 is a block diagram showing main functional configuration of the image forming device.

FIG. 3 shows the photosensitive drum and the lubrication mechanism of the image forming device at an early stage of use.

FIG. 4 shows the photosensitive drum and the lubrication mechanism of the image forming device at a terminal stage of use.

FIG. 5 shows the photosensitive drum and the lubrication mechanism of the image forming device in a detection mode of a first detection method.

FIG. 6 shows the photosensitive drum and the lubrication mechanism of the image forming device in the detection mode of a second detection method.

FIG. 7 is a graph showing relation between a linear velocity ratio θ of an application brush and a friction force.

FIG. 8 is an enlarged view of a part of FIG. 7.

FIG. 9 is a graph showing the relation between the linear velocity ratio θ of the application brush and a friction force F1 at different temperatures.

FIG. 10 is a flowchart showing a flow of processing for estimation of a remaining amount of a lubricant rod.

### DESCRIPTION OF EMBODIMENTS

Hereinafter, one or more embodiments of the present invention will be described with reference to the drawings. However, the scope of the invention is not limited to the disclosed embodiments.

The present embodiment is an electrophotographic image forming device including configurations described below.

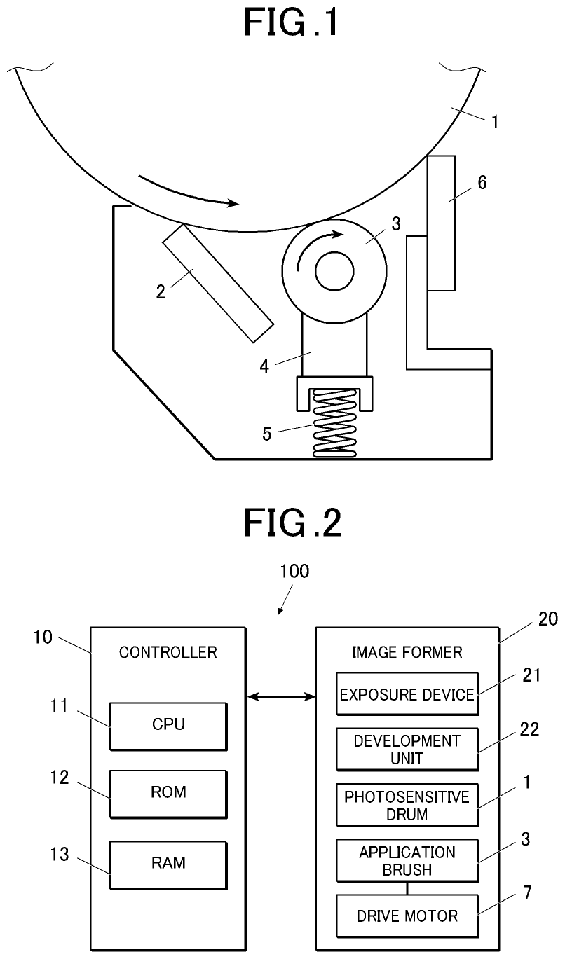

FIG. 1 shows a lubrication mechanism that applies a lubricant to a photosensitive drum 1 as an image carrier of the image forming device of the embodiment. FIG. 2 shows configuration of a main part of the image forming device.

The photosensitive drum 1 rotates counterclockwise. A cleaning blade 2 touches the photosensitive drum 1 to remove a toner and external additives. An application brush 3 touches the photosensitive drum 1 downstream of the cleaning blade 2 in a direction of rotation of the photosensitive drum 1. The application brush 3 is rotated clockwise by rotation of the photosensitive drum 1. The application brush 3 is held so that a distance between axes of the application brush 3 and the photosensitive drum 1 is constant and a pushing amount (overlap) is 1 mm. An initial value of a linear velocity ratio θ of the application brush 3 to the photosensitive drum 1 is set to a value more than 1, for example, 1.3. The linear velocity ratio θ is appropriately changed according to consumption and environment.

A solidified lubricant rod 4 is pressed against the application brush 3 by elastic force of a press spring 5. The application brush 3 rotates to scrape a lubricant from the lubricant rod 4, and supplies the lubricant to the photosensitive drum 1. The press spring 5 is a lubricant pressing unit that presses the lubricant rod against the application brush 3. The lubricant rod 4 is consumed to get shorter. Then, pressure between the lubricant rod 4 and the application brush 3 due to elastic force of the press spring 5 gets smaller according to Hooke's law. Along with this, a friction force (F2) between the application brush 3 and the lubricant rod 4 gets smaller.

An immobilization blade 6 touches the photosensitive drum 1 on the downstream side of the application brush 3. A contact portion at a tip of the immobilization blade 6 faces downstream.

The application brush 3 is connected to a drive motor 7. A rotation speed of the application brush 3 can be changed independently by control of a controller 10. A drive load is measured by measuring a current value of the drive motor 7. A current value of the drive load is input to the controller 10.

The controller 10 of the image forming device 100 controls rotation drive of the application brush 3, image forming operation, a detection mode for estimating a remaining amount of the lubricant rod, and the like.

The controller 10 includes a CPU (central processing unit) 11, ROM (read only memory) 12, and RAM (random access memory) 13. The CPU 11 reads a program for contents of processing from the ROM 12 and develops it in the RAM 13. The CPU 11 cooperates with the developed program to comprehensively control operation of parts of the image forming device 100.

An electrophotographic image former 20 includes:

an exposure device 21 that draws an electrostatic latent image on the photosensitive drum 1;

a developing unit 22 that develops the electrostatic latent image into a toner image; and

other well-known configurations, such as a charging device.

In addition to the image former 20, the image forming device 100 further includes an image reader, an operation display, an image processor that processes image data, an intermediate transfer unit, a paper conveyor, a fixing unit, a memory, a communicator, and the like according to necessity.

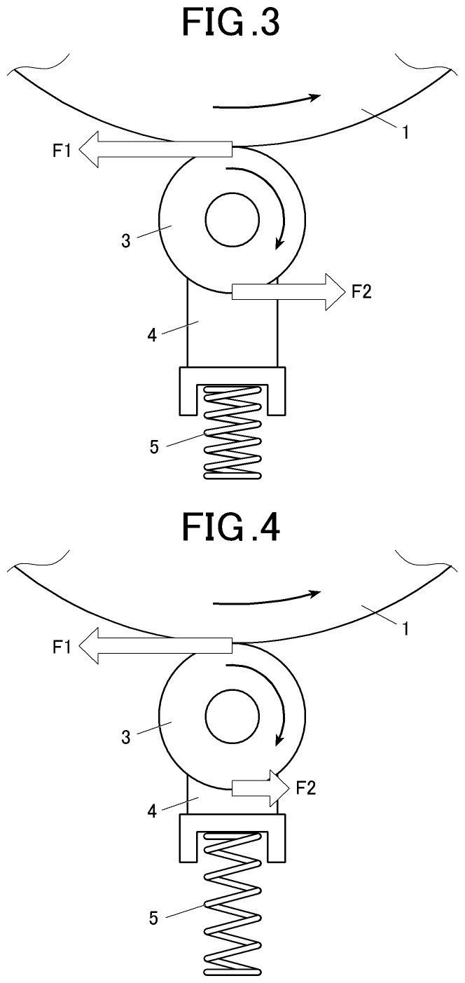

FIG. 3 and FIG. 4 show a friction force F (F1, F2) generated with rotation of the application brush 3. FIG. 3 shows a state in which the lubricant rod 4 has a sufficient remaining amount at an early stage of use. FIG. 4 shows a state in which the lubricant rod 4 has a very small remaining amount at a terminal stage of use.

The friction force F acting on the application brush 3 is the sum of:

a friction force F1 between the application brush 3 and the photosensitive drum 1; and

a friction force F2 between the application brush 3 and the lubricant rod 4.

In a case where the linear velocity ratio θ is set to a value more than 1, both the friction forces F1, F2 work to stop the application brush 3. That is, both the friction forces F1, F2 have effect of decelerating the application brush 3.

The friction force F1 depends on:

the pushing amount of the application brush 3 against the photosensitive drum 1;

a stiffness of brush fibers; and

a coefficient of friction of the photosensitive drum 1.

Since change in an outer diameter of the application brush 3 while being used is very small, change in the pushing amount can be ignored. The stiffness of the brush fibers depends on temperature. The higher the temperature, the lower the stiffness. Therefore, the friction force F1 varies depending on the temperature. The friction coefficient of the photosensitive drum 1 depends on the lubrication amount. However, if the lubrication amount is equal to or more than a predetermined amount, fluctuation of the friction coefficient can be ignored.

The friction force F2 is proportional to a lubricant pressure while the lubricant pressure is proportional to a displacement amount of the press spring 5. Since the lubricant rod 4 wears as it is consumed, the displacement amount of the press spring 5 decreases. Therefore, the friction force F2 decreases. A remaining amount of the lubricant rod 4 can be estimated by measuring ΔF2 which is obtained by subtracting current F2 from F2 at an early stage. However, in general, the rotation speed of the application brush 3 is relatively large when the application brush 3 applies the lubricant to the photosensitive drum 1 in image forming operation (hereinafter referred to as “regular operation”). Therefore, as shown in FIGS. 3 and 4, F1 is larger than F2. It is difficult to detect ΔF2 by measuring the drive load of the drive motor 7 in that state.

The controller 10 executes the detection mode. In the detection mode, the controller 10 controls the rotation speed of the application brush 3, and detects a value of the drive load of the application brush 3 corresponding to the rotation speed. The controller 10 estimates a remaining amount of the lubricant rod 4 based on the value of the drive load of the application brush 3 and/or on the rotation speed of the application brush 3 at a time of detection.

In the detection mode. the controller 10 variably controls the rotation speed of the application brush 3 in relation to a rotation speed of the photosensitive drum 1. Detection ability is enhanced by variably controlling the linear velocity ratio θ. The remaining amount of the lubricant rod 4 is accurately estimated.

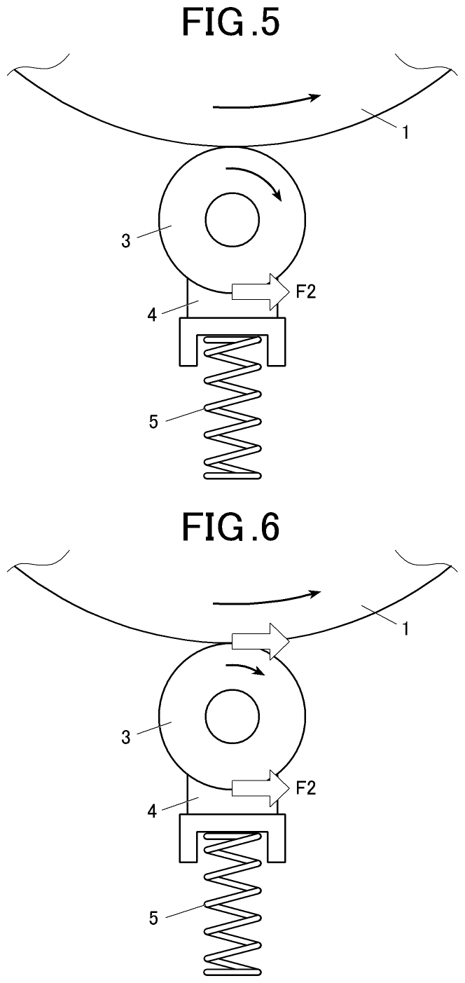

FIG. 5 and FIG. 6 show operation states of the application brush in the detection mode. FIG. 5 shows an operating state in a first detection method. FIG. 6 shows an operating state in a second detection method. It is common to those detection methods that the drive load of the drive motor 7 is measured to estimate the remaining amount of the lubricant rod 4. The application brush is controlled such that the linear velocity ratio 0 is different from that in the regular operation. Details will be described below.

First Detection Method

The controller 10 sets the linear velocity ratio θ to 1, and measures the drive load of the application brush 3. That is, the controller 10 executes the detection mode in which the rotation speed of the application brush 3 is controlled such that the linear speeds of the photosensitive drum 1 and the application brush 3 are the same. The controller 10 estimates the remaining amount of the lubricant rod 4 based on the value of the drive load of the application brush 3 at this time. The controller 10 estimates the remaining amount of the lubricant rod 4 by comparing the value of the drive load of the application brush 3 with a predetermined criterion for determination.

According to this detection mode, as shown in FIG. 5, the friction force F1 becomes almost zero, and only F2 is the drive load. Therefore, detection ability for ΔF2 gets higher. The linear velocity ratio θ is calculated from values calculated from a design outer diameter and the rotation speed of the application brush 3. A setting error of about ±2% is tolerated. For example, in a case where a linear velocity of the photoreceptor is 500 mm/s, a linear velocity of the application brush can be 490 to 510 mm/s.

Second Detection Method

The controller 10 changes the rotation speed of the application brush 3 such that the linear velocity ratio θ is less than 1. The controller 10 detects the linear velocity ratio θ at which the drive load of the application brush 3 is substantially zero. That is, the controller 10 executes a detection mode in which the rotation speed of the application brush 3 is controlled such that the value of the drive load of the application brush 3 is substantially zero. The controller 10 estimates the remaining amount of the lubricant rod 4 based on the rotation speed of the application brush 3 at this time. The controller 10 estimates the remaining amount of the lubricant rod 4 by comparing the rotation speed of the application brush 3 with a predetermined criterion for determination.

In a case where θ is set to a value less than 1, the friction force F1 works to assist the application brush 3 as shown in FIG. 6. That is, the friction force F1 increases the speed of the application brush 3. The friction force F2 decelerates the application brush 3.

The controller 10 performs feedback control so that the value of the drive load of the application brush 3 becomes substantially zero. It brings a state in which the friction force F1 and the friction force F2 offset each other.

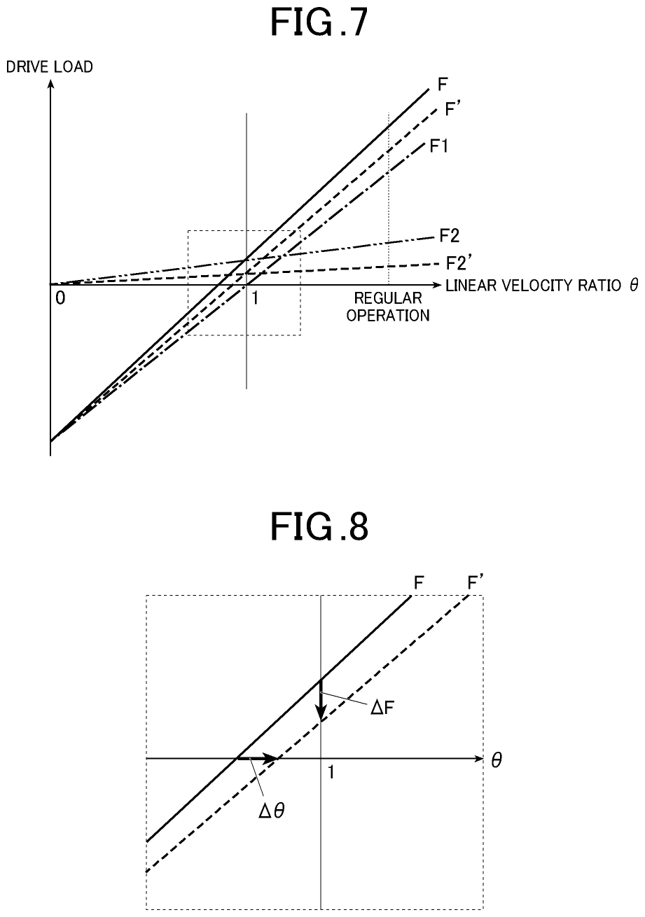

FIG. 7 is a graph showing relation between the linear velocity ratio θ and the friction forces F, F1 and F2. The horizontal axis represents the linear velocity ratio θ, and the vertical axis represents the drive load of the application brush 3. On the graph, the solid lines (F, F1, F2) indicate relations at an early stage of use. Dotted lines (F′, F2′) indicate relations at a terminal stage of use. FIG. 8 is an enlarged view of a part around the area of θ=1.

The linear velocity ratio θ is a ratio of the linear velocity of the application brush 3 to the linear velocity of the photosensitive drum 1. If the linear velocity ratio θ is 0, it means that the application brush 3 is in a stopped state.

The friction force F1 is a friction force between the application brush 3 and the photosensitive drum 1. If the linear velocity ratio θ is 1, the friction force F1 is zero. If θ is less than 1, the photosensitive drum 1 overtakes the application brush 3. The friction force F1 becomes a negative value.

The friction force F2 is a friction force between the application brush 3 and the lubricant rod 4. In a state where the application brush 3 is stopped, if the linear velocity ratio θ is 0, the friction force F2 is zero. As the application brush 3 starts to move, the friction force F2 increases uniformly.

As described above, the friction force F1 does not change as the lubricant rod 4 is consumed while the friction force F2 gradually decreases. Since the friction force F is the sum of the friction force F1 and the friction force F2, the friction force F changes as shown in the figure.

The first detection method is a detection mode in which the drive load is detected with the linear velocity ratio θ set to 1. Therefore, as shown in FIG. 8, a difference ΔF indicated by a vertical arrow appears between the early stage of use (F) and the terminal stage of use (F′).

In the second detection method, control is performed such that the linear velocity ratio θ becomes a value that makes the drive load of the application brush 3 become zero. Therefore, a difference Δθ indicated by a horizontal arrow appears.

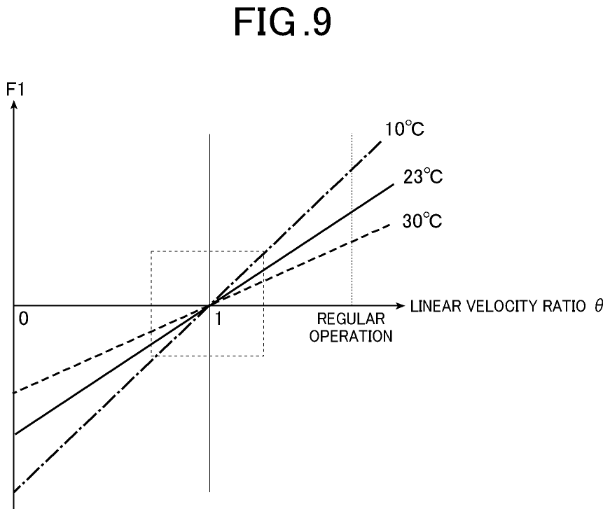

FIG. 9 is a graph showing relation between the linear velocity ratio θ and the friction force F1. Changes at 23° C. (normal environment), 30° C., and 10° C. are shown by a solid line, a dotted line, and a dashed line, respectively. At high temperature, a Young's modulus of fibers of the application brush 3 decreases, so inclination is gentle. At low temperature, a Young's modulus is high, so inclination is steep.

Difference in the friction force F1 between temperatures can be predicted by knowing a value in a normal environment. When the normal environment is detected at an early stage where a new photosensitive drum 1 is set, the drive load is measured by variably controlling the linear velocity ratio θ. The drive load is held as a reference value.

An ambient temperature while the detection mode is executed is measured. Determination is performed using a value obtained by multiplying the reference value by a conversion coefficient of detected temperature. Thus, the friction force F1 varies depending on a temperature at which the detection mode is executed while F2 does not fluctuate. Therefore, the measured drive load is converted to a value in the normal environment and is compared with an initial value. It improves accuracy in estimation of a remaining amount.

Determination may be performed by preparing a table at each temperature instead of multiplication by the conversion coefficient.

As described above, the controller 10 detects an environmental temperature of the image forming device 100. The predetermined criterion is changed according to the detected temperature.

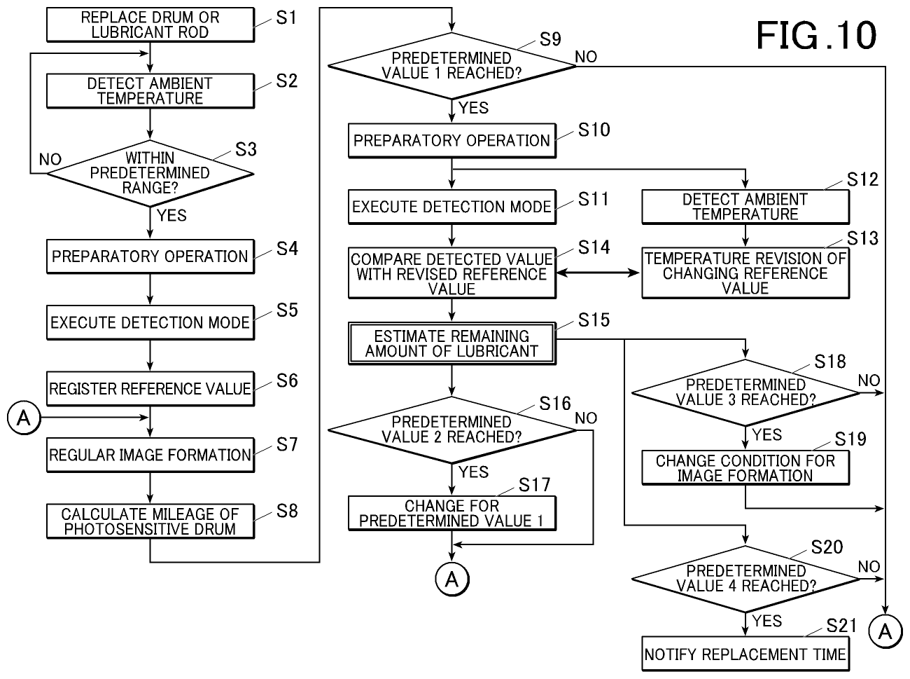

FIG. 10 is a flowchart showing a flow in processing of estimation of a remaining amount of the lubricant rod according to the embodiment.

Steps S1-S6 correspond to a flow up to registration of the reference value (described above), which is executed when the photosensitive drum 1 or the lubricant rod 4 is replaced. Step S7 and subsequent steps correspond to a flow from the regular operation of image formation to execution of the detection mode as well as determination processing of various kinds.

First, when the photosensitive drum 1 or the lubricant rod 4 is replaced (S1), the controller 10 detects the ambient temperature (environmental temperature of the image forming device 100) to obtain the reference value for determination (S2). If the ambient temperature is within a specified range (YES in S3), the controller 10 performs preparatory operation of rotating the photosensitive drum 1 and the application brush 3 for a predetermined time to keep a lubrication amount for the photosensitive drum 1 at a predetermined value (S4). The controller 10 lowers the rotation speed of the application brush 3 and executes the detection mode (S5). The controller 10 applies the detection mode in the first or second detection method.

The controller 10 registers the reference value for determination (drive load value or linear velocity ratio θ) obtained in the detection mode together with the ambient temperature in step S2 (S6).

Then, the controller 10 shifts to regular image formation. The controller 10 sets the rotation speed of the application brush 3 to a value in the regular operation (S7). The controller 10 starts to calculate a mileage of the photosensitive drum 1 (S8).

A threshold value for a time to execute the detection mode is registered in advance as a predetermined value 1. In the embodiment, the predetermined value 1 is defined by means of the mileage of the photoreceptor.

If a calculated value of the mileage of the photosensitive drum 1 reaches the predetermined value 1 (YES in S9), the controller 10 performs preparatory operation of rotating the photosensitive drum 1 and the application brush 3 for a predetermined time to keep a lubrication amount for the photosensitive drum 1 at a predetermined value (S10) like Step S4. The controller 10 reduces the rotation speed of the application brush 3 and executes the detection mode in the same method as in Step S5 (S11). The preparatory operation is operation for stabilizing an amount of lubricant on the photosensitive drum 1. For example, operation that does not form any image is performed for a predetermined time. Alternatively, usual image stabilizing operation is performed. The controller 10 may execute the detection mode at a predetermined time based on a mileage of the photosensitive drum 1 or the application brush 3, or the driving period thereof, not the mileage of the photosensitive drum 1 only.

The controller 10 detects the ambient temperature (environmental temperature of the image forming device) (S12) while executing the detection mode (S11). The controller 10 performs temperature revision of changing the reference value for determination, which is registered in Step S6, according to an amount of difference between the ambient temperature registered in Step S6 and the ambient temperature at this time (S13).

The controller 10 compares the reference value revised in step S13 with a value detected in the detection mode in step S11 (S14). In the first detection method, the detected value is the drive load of the application brush 3. In the second detection method, the detected value is the linear velocity ratio θ of the application brush 3. Thereby the controller 10 estimates a remaining amount of the lubricant rod 4 (S15).

The controller 10 presets predetermined values 2, 3 and 4 to be compared with the remaining amount of the lubricant rod 4 estimated in step S15.

The predetermined value 2 is a threshold value for changing time to execute the detection mode. If the remaining amount of the lubricant rod 4, which is estimated in step S15, reaches the predetermined value 2 (YES in S16), the controller 10 changes execution time of the predetermined value 1 (S17). Detection is frequent at the terminal stage of use. It prevents occurrence of problem due to depletion of lubricant.

The predetermined value 3 is a threshold value of time to change a condition for image formation.

If the remaining amount of the lubricant rod 4, which is estimated in step S15, reaches the predetermined value 3 (YES in S18), the controller 10 changes the condition for image formation (S19). As the remaining amount of the lubricant rod decreases, the lubricant pressure decreases, and consumption of the lubricant decreases. Therefore, an amount of lubricant on the photosensitive drum 1 is reduced. To correct this, the condition for image formation is changed. For example, a lubricant consumption is kept constant by increasing the linear velocity ratio θ of the application brush 3. The predetermined values 3 at multiple levels may be set. In that case, the condition for image formation including the linear velocity ratio θ of the application brush 3 is changed at multiple levels.

The predetermined value 4 is a threshold value for determining a life of the lubricant rod 4.

If the remaining amount of the lubricant rod 4, which is estimated in step S15, reaches the predetermined value 4 (YES in S20), the controller 10 notifies that it is time to replace the lubricant rod 4 (S21). It prevents problem due to depletion of lubricant. The predetermined values 4 at multiple levels may be set. In that case. the replacement time will be notified at multiple levels. Notification of the replacement time may be display on a panel or notification to a service center. When the controller 10 notifies the replacement time, the controller 10 may stop image forming operation based on decision at the final stage.

### ADVANTAGEOUS EFFECTS AND SO ON

According to the above embodiment, the detection mode for detecting a value of the drive load of the application brush 3 corresponding to the rotation speed (linear speed ratio θ) is executed. Thereby a remaining amount of the lubricant rod 4 is estimated. Therefore, the remaining amount of the lubricant rod 4 is estimated while increase in the number of hardware elements such as a detection circuit is suppressed. It realizes a function of detecting a remaining amount of a lubricant rod at low cost.

In the detection modes in the first and second detection methods, control is performed such that either one of the linear velocity ratio θ and the drive load value of the application brush 3 becomes a predetermined value. At least one pair of the linear velocity ratio θ of the application brush 3 and a value of the corresponding drive load is detected and is plotted in FIG. 7. A remaining amount of the lubricant rod 4 is estimated by checking how closer the plotted point is to the graph F′ than to the graph F. For example, the two-dimensional graph F′ in FIG. 7 is acquired in advance for each model as the reference value for determination. It allows estimation. Thus, the controller 10 executes the detection mode of controlling the rotation speed of the application brush 3 and detecting a value of the drive load of the application brush 3 corresponding to the rotation speed. Thereby, the controller 10 estimates a remaining amount of the lubricant rod based on the value of the drive load of the application brush 3 and the rotation speed of the application brush 3 at the time of detection.

However, as described above, when the rotation speed is high in the regular operation, a component of the friction force F1 is large. It makes it difficult to accurately detect the friction force F2. Therefore, in the detection mode, the controller 10 controls the rotation speed of the application brush 3 to make it lower than the rotation speed in the regular operation. It reduces influence of the friction force F1 and improves accuracy in detection of the friction force F2. The first and second detection methods also correspond to this.

In the first detection method, the friction force F1 is reduced to almost zero, and the accuracy in detection of the friction force F2 is improved. In the second detection method, the friction force F1 and the friction force F2 offset each other in opposite directions. It stabilizes operation state and improves accuracy in detection of the friction force F2. In the first and second detection methods, as in Steps S1-S6, it is easy to acquire the reference value for determination for each image forming device and for each replacement of related elements. It is not always necessary to acquire the two-dimensional graph F′ in FIG. 7.

As described above, the rotation speed of the application brush 3 is changed, and a remaining amount is detected. It increases detection sensitivity for the friction force F2, which is a component that varies depending on consumption of the lubricant rod 4. Accuracy in estimation of detection of a remaining amount of the lubricant rod 4 is improved.

Change in time to execute the detection mode, change in the condition for image formation, and notification of replacement time is performed appropriately based on result of detection of the remaining amount. It maintains stable images and prevents defects in images.

The scope of the present invention is not limited to the above-described embodiment, and includes various modifications within the scope of the claims of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2020-099007, filed on Jun. 8, 2020, is incorporated herein by reference in its entirety.

What is claimed is:

1. A lubrication mechanism that applies a lubricant to an image carrier of an image forming device, comprising:
a lubricant rod that is solidified;
an application brush that scrapes the lubricant from the lubricant rod and supplies the lubricant to the image carrier;
a lubricant pressing part that presses the lubricant rod against the application brush; and
a controller that controls rotational drive of the application brush,
wherein
the controller executes a detection mode of controlling a rotation speed of the application brush and detecting a value of a drive load of the application brush which corresponds to the rotation speed, and
the controller estimates a remaining amount of the lubricant rod based on the value of the drive load of the application brush and/or the rotation speed of the application brush at a time of detection.

2. The lubrication mechanism according to claim 1, wherein, in the detection mode, the controller controls the rotation speed of the application brush such that a value of the rotation speed is less than a value of the rotation speed when the lubricant is applied to the image carrier in image forming operation.

3. The lubrication mechanism according to claim 1, wherein
the controller controls the rotation speed of the application brush such that linear speeds of the image carrier and the application brush are same in the detection mode, and
the controller estimates the remaining amount of the lubricant rod by comparing the value of the drive load of the application brush with a predetermined criterion for determination.

4. The lubrication mechanism according to claim 1, wherein
the controller controls the rotation speed of the application brush such that the value of the drive load of the application brush is substantially zero in the detection mode, and
the controller estimates the remaining amount of the lubricant rod by comparing the rotation speed of the application brush with a predetermined criterion for determination.

5. The lubrication mechanism according to claim 3, wherein the controller detects an environmental temperature of the image forming device, and changes the predetermined criterion for determination according to the detected temperature.

6. An image forming device, comprising:
the lubrication mechanism according to claim 1,
wherein
the controller executes preparatory operation before executing the detection mode, and
in the preparatory operation, the controller rotates the image carrier and the application brush for a predetermined time to keep the lubrication amount for the image carrier at a predetermined value.

7. An image forming device, comprising:
the lubrication mechanism according to claim 1,
wherein the controller changes a condition for image formation according to result of estimation of the remaining amount of the lubricant rod.

8. An image forming device, comprising:
the lubrication mechanism according to claim 1,
wherein the controller executes the detection mode at a predetermined time based on a mileage of the image carrier or the application brush, or a driving period thereof.

9. The image forming device according to claim 8, wherein the controller changes the predetermined time according to result of estimation of the remaining amount of the lubricant rod.

10. An image forming device, comprising:
the lubrication mechanism according to claim 1,
wherein the controller notifies time to replace the lubricant rod according to result of estimation of the remaining amount of the lubricant rod.
